(19) United States
(12) Patent Application Publication
(10) Pub. No.: US 2013/0067142 A1
(43) Pub. Date: Mar. 14, 2013

(54) FLASH MEMORY STORAGE DEVICE AND METHOD OF JUDGING PROBLEM STORAGE REGIONS THEREOF

(71) Applicants: Young-Joon Choi, Suzhou (CN); Kuo-Chung Liao, Suzhou (CN); Yen-Hsin Liu, Suzhou (CN); Chiang-Chang Hsien, Suzhou (CN); Yun-Hui Wang, Suzhou (CN); Chih-Ming Hsu, Suzhou (CN)

(72) Inventors: Young-Joon Choi, Suzhou (CN); Kuo-Chung Liao, Suzhou (CN); Yen-Hsin Liu, Suzhou (CN); Chiang-Chang Hsien, Suzhou (CN); Yun-Hui Wang, Suzhou (CN); Chih-Ming Hsu, Suzhou (CN)

(73) Assignee: A-DATA TECHNOLOGY (SUZHOU) CO.,LTD., Suzhou (CN)

(21) Appl. No.: 13/425,990

(22) Filed: Mar. 21, 2012

(30) Foreign Application Priority Data
Sep. 14, 2011 (TW) 100133003

(51) Int. Cl. G06F 12/02

(52) U.S. Cl. 711/103; 711/E12.008

(57) ABSTRACT

A method of judging problem storage regions adapted for a flash memory storage device includes steps of: sending a writing order to a flash memory chip for writing a written data to an appointed storage paging; when the flash memory chip beginning writing the written data to the appointed storage paging, getting the first time; when the flash memory chip finishing writing the written data to the appointed storage paging, getting the second time; calculating a writing time according to the first time and the second time; if the writing time not coincident with a standard value, then labeling the appointed storage paging as a problem storage region and copying the written data to a backup paging; updating a Mapping Table.

### BACKGROUND OF THE INVENTION

1. Description of Related Art

The present invention relates to a flash memory storage device and the judgment method thereof, more particularly to a method of judging problem storage regions of the flash memory storage device.

2. Description of Related Art

Flash memory is a non-volatile storage with advantages of high storage density, low power consumption, effective storage efficiency, and reasonable price cost etc. In flash memories, NAND (NAND Gate)-type flash memory is the main type and usually used in a device, such as a memory card, a U-disk, a solid disk driving device etc., and a memory system consisting an electronic equipment.

Since data signals recorded in memory units of a flash storage will become weak with time which causes the reliability of written data also become decreased, Error Correction Code (ECC) system is hence built for detecting and correcting error codes of the data. In a data writing period, ECC is generated by an ECC module coded according to content of the data, and stored into redundancy regions of a paging together with the data. When reading data from a paging, another group of ECC generated by the ECC module coded according to current content of the data, then compared with the original ECC to pick up and correct the error codes of the data.

However, error correction ability of the ECC module is limited. If the amount of the error codes of the data exceeds an error correction limitation, then, not all error data can be corrected. In the prior arts, the error correction ability of ECC is higher than the error codes of the data usually for assuring the reliability of data correction. Through setting limited value of the amount of the error codes of the data, the storage regions which have the amount of the error codes of the data in a paging more than the limited value will be judged as problem storage regions and be eliminated in time. In details, in a reading period, when the amount of the error codes of the data is judged as more than the limited value, the paging being read or the region to which the paging belongs will be judged as problem storage region by the storage device. Then the paging or the region to which the paging belongs will be labeled as destroyed storage region in a particular location, and the corrected data will be copied to other substantial location in the memory to end the use of the problem storage region.

But some problems may exist in the judging mode of the above problem storage region: The judgment of the problem storage region is only operated in the reading period. If the storage ability of the paging has become weak before the data is written into, then the result is that the amount of error of the inner data increases a lot after the data is written. Then, in the following data reading on the problem paging, the amount of error codes of the data is in great possibility more than the error correction limitation of the storage device, which causes the error data cannot be restored as correct data.

### BRIEF SUMMARY OF THE INVENTION

Accordingly, an object of the present invention is to provide a flash memory storage device which is capable of verifying problem storage regions thereof.

Another object of the present invention is to provide a method of judging problem storage regions of a flash memory storage device.

In order to achieve the above-mentioned object, a flash memory storage device comprises a flash memory chip, and a memory controller. The flash memory chip comprises a plurality of region blocks each comprising a plurality of pagings. The flash memory chip comprises a state output port for outputting a state signal, wherein when the flash memory chip is in an armed state, the standard level of the state signal is a first logical value, while when the flash memory chip is in a working state, the standard level of the state signal is a second logical value. The memory controller controls the access to the flash memory chip. When the memory controller sends a writing order to said flash memory chip for writing a written data to an appointed storage paging of the pagings, the memory controller gets the first time when the state signal changes from the first logical value to the second logical value, and the memory controller gets the second time when the state signal changes from the second logical value to the first logical value. The memory controller calculates a writing time according to the first time and the second time and judges whether the writing time is coincident with a standard value. If the writing time is not coincident with the standard value, the memory controller controls the flash memory chip to label the appointed storage paging as a problem storage region and copy the written data to a backup paging, and updates a Mapping Table according to the information of labeling the appointed storage paging as the problem storage region and the backup information of said written data.

In order to achieve the above-mentioned object, a method of judging problem storage regions adapted for a flash memory storage device, wherein the flash memory storage device comprises a flash memory chip which comprises a plurality of region blocks, and each region block comprises a plurality of pagings. The method of judging problem storage regions comprises steps of: sending a writing order to the flash memory chip for writing a written data to an appointed storage paging of the pagings; getting the first time when the flash memory chip starting writing said written data to the appointed storage paging; getting the second time when the flash memory chip finishing writing the written data to the appointed storage paging; calculating a writing time according to the first time and the second time; judging whether the writing time is coincident with a standard value; if the writing time is not coincident with the standard value, labeling the appointed storage paging as a problem storage region and copying said written data to a backup paging; and updating a Mapping Table according to the information of labeling the appointed storage paging as a problem storage region and the backup information of the written data.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a function block diagram of a flash memory storage device in accordance with the first embodiment of the present invention;

FIG. 2 is a function block diagram of the flash memory storage device in accordance with the second embodiment of the present invention;

FIG. 3 is a function block diagram of a control module of a memory controller in accordance with the present invention;

FIG. 4 is a time sequence schematic view of the state signal of a flash memory chip in accordance with the present invention;

FIG. 5 is a flowchart illustrating the method of judging problem storage regions in accordance with the first embodiment of the present invention;

FIG. 6 is a flowchart illustrating the method of judging problem storage regions in accordance with the second embodiment of the present invention; and

FIG. 7 is a flowchart illustrating the method of judging problem storage regions in accordance with the third embodiment of the present invention.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

The method of judging problem storage regions of a flash memory storage device of the present invention is mainly by monitoring the writing period of data of the flash memory chip, to verify storage ability of the storage regions, hence picking up problem storage regions and eliminating the problem storage regions in time.

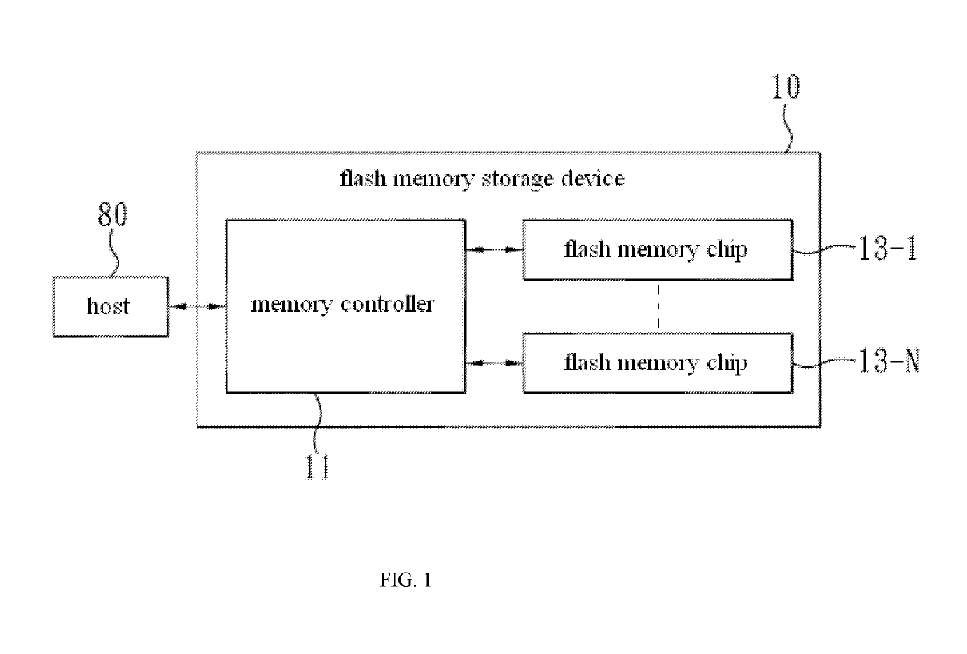

Firstly, please refer to FIG. 1, which is the function block diagram in accordance with the first embodiment of the flash memory storage device of the present invention. As illustrated in FIG. 1, a flash memory storage device (shortened as storage device hereinafter) 10 comprises a memory controller 11 and a plurality of flash memory chips 13-1, . . . 13-N. The flash memory chips 13-1, . . . 13-N are data storage regions consisting of NAND-type flash memories. The memory controller 11 is coupled between a host 80 and the flash memory chips 13-1, . . . 13-N. The memory controller 11 receives access commands from an outer host 80, then controls visit to the flash memory chips 13-1, . . . 13-N, that is, writing data into the flash memory chips 13-1, . . . 13-N or reading data from the flash memory chips 13-1, . . . 13-N.

The storage device 10 could be an independent data storage device, such as a memory card, a U disk, a solid disk driver etc., or a memory system in different kinds of electronic devices, such as a mobile phone, an audio player, a video device etc. For example, in one embodiment of the present invention, the host 80 and the storage device 10 are two independent devices. The host 80 is a computer system, while the storage device 10 is a data storage device connecting to the computer system 80. In an alternative embodiment of the present invention, the host 80 and the storage device 10 are integrated into one electronic device, the host 80 is the central process unit for the electronic device, while the storage device 10 is the memory system of the electronic device.

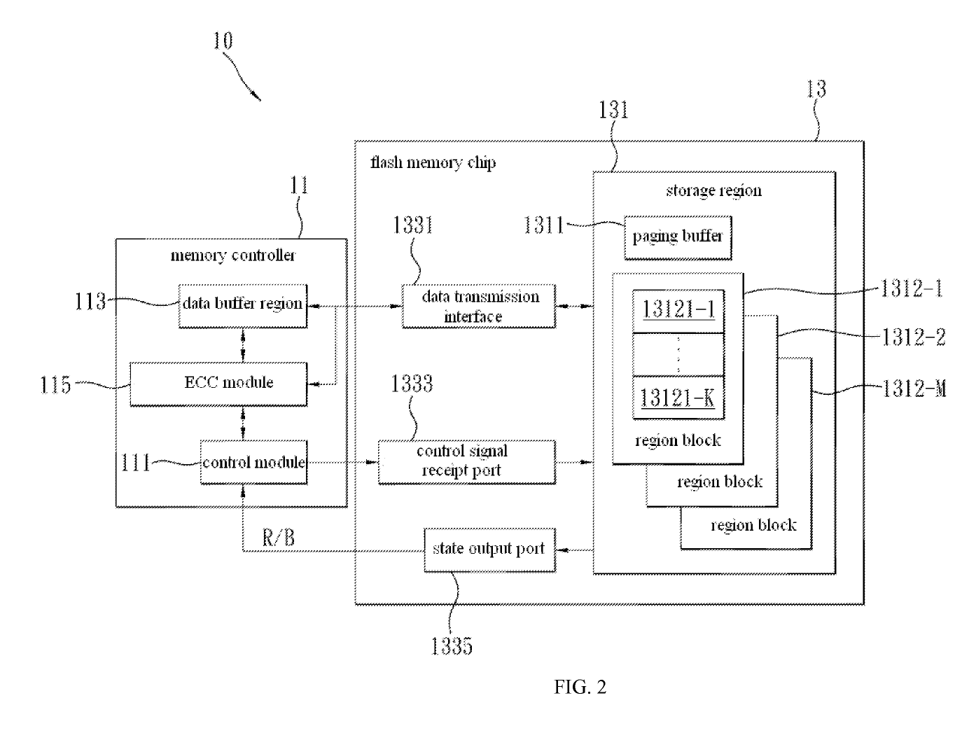

Please refer to FIG. 2, which is the function block diagram of the second embodiment of the storage device of the present invention. In the second embodiment, the storage device 10 is simplified as a single flash memory chip 13 for explaining the structure of the memory controller 11 and the flash memory chip 13 in detail. As shown in FIG. 2, the memory controller 11 comprises a control module 111, a data buffer region 113 and an ECC module 115. The flash memory chip 13 comprises a storage region 131, a data transmission interface 1331, a control signal receipt port 1333 and a state output port 1335.

In the memory controller 11, the control module 111 sends a writing order, a reading order or an erasing order to the flash memory chip 13 according to the commands of an outer host, and controls the operation of other function modules of the memory controller 11. The data buffer region 113 is served as a data temporary storage region during the host and the flash memory chip 13 transmit data therebetween. The ECC module 115 receives control from the control module 111 to code and decode the ECC for the temporary data in the data buffer region 113.

It should be noted that the storage device 10 records the corresponding relationship between the logical location and the substantial location of the data by a Mapping Table. The Mapping Table could be stored in the program memory of the memory controller 11, or stored in the storage region 131 of the flash memory chip 13. When the system is started, the control module 111 can access the data of the Mapping Table. Further, when the host requires reading data, the control module 111 converts the required access logical addresses into substantial addresses to consist access orders which are sent to the flash memory chip 13. When the host requires writing data, the control module 111 collocates substantial addresses to consist write orders. Then the control module 111 updates the Mapping Table according to the relationship between the logical addresses and the substantial addresses of the written data.

Please refer to FIG. 2 again, in the flash memory chip 13, the storage region 131 is the substantial location for data storage. The storage region 131 comprises a paging buffer 1311 and a plurality of region blocks 1312-1 . . . 1312-N. Each region block comprises a plurality of pagings. For example, the region block 1312-1 has pagings 13121-1 . . . 13121-N. NAND-type flash memory chip usually comprises 4096 region blocks, and each region block comprises 256 pagings. The flash memory chip 13 uses paging as data access unit. The paging buffer 1311 is served as temporary data storage. When the memory controller 11 writes data into the paging of the flash memory chip 13, the data will be firstly sent to the paging buffer 1311 for temporary storage, then the flash memory chip 13 writes the data stored the paging buffer 1311 to a paging appointed by the writing order.

The data transmission interface 1331 is coupled between the data buffer region 113 and the storage region 131 for bidirectional data transmission. The control signal receipt port 1333 is coupled between the control module 111 and the storage region 131 for receiving control signals from the control module 111, such as writing or reading orders, hence controlling the operation of the storage region 131. The state output port 1335 is coupled between the control module 111 and the storage region 131, for a state signal R/B output to the memory controller 11.

The state signal R/B will be explained detailedly hereinafter. The state signal R/B is used for indicating the real-time state of the flash memory chip 13. When the flash memory chip 13 does not execute paging access or region erase actions to the storage region 131, the state thereof is in an armed state, and the flash memory chip 13 controls the standard level of the state signal R/B in the first logical value. Contrariwise, when the flash memory chip 13 receives control of the memory controller 11 to execute paging access or region erase to the storage region 131, the flash memory chip 13 is in working state, and the signal standard level of the state signal R/B is of the second logical value controlled by the flash memory chip 13. The first logical value could be high standard level or low standard level. While, the second logical value could be the contrary value of the first logical value.

A flash memory chip usually is equipped with R/B (or RY/BY) pin whose function is as described for the state output port 1335, that is, representing the state of the chip via controlling the logical value of the pin output signal.

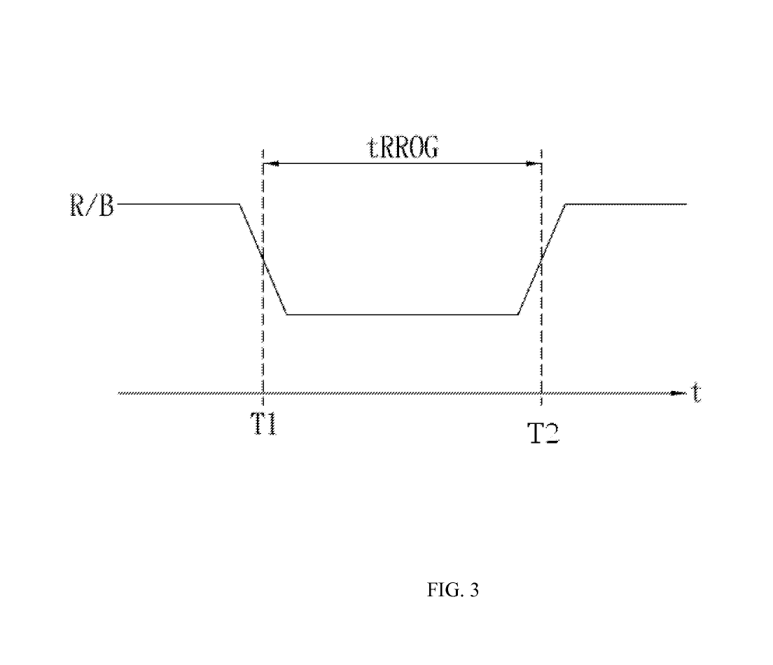

Please refer to FIG. 3 which is the time sequence schematic view of the state signal, and illustrates the standard level change of the state signal R/B when the flash memory chip 13 executes paging writing. As shown in FIG. 3, if the state signal R/B is of high standard level, then the flash memory chip 13 is indicated as in the armed state. If the signal standard level of the state signal R/B changes from high to low, that means paging writing is executed. If the signal standard level of the state signal R/B changes from low to high, that means paging writing is ended.

As illustrated in FIG. 3, the writing time tPROG of the paging is the time period of the low standard level signal of the state signal R/B. The writing time tPROG is achieved by calculating the first time T1 which is the time period of the state signal R/B changing from high standard level to low standard level, and the second time T2 which is the time period of the state signal R/B changing from low standard level to high standard level. The writing time of the paging is relevant to the storage quality. The writing time of a paging having normal storage ability is shorter than a standard value which varies according to memory categories. Usually, the later manufacture process of a flash memory chip will test the writing time of all pagings to check valid pagings with writing time exceeds the limited value.

The above testing mechanism is only used in the manufacturing process of a flash memory chip. Current early retirement mechanism of problem storage region of a flash memory judges problem storage region only by the amount of error codes in a data reading period. In the present invention, the flash memory storage device is equipped with function of monitoring the writing time of a paging by which to judge the quality of the storage region, thus the early retirement mechanism for problem storage region of the flash memory is more effective.

Please refer to FIG. 2 again, when the memory controller 11 receives data writing order from the host 80, the memory controller 11 distributes substantial addresses to the written data to consist the writing order and sends the writing order to the flash memory chip 13, which controls the flash memory chip 13 to write the written data into the appointed storage paging. The written data is stored in the data buffer region 113 of the memory controller 11, and after the ECC module 115 codes ECC, the written data is sent to the paging buffer 1311 via the data transmission interface 1331. Then, when the memory controller 11 detects that the state signal R/B changes from the first logical value into the second logical value, the time when the signal standard level changes is the first time. When the memory controller 11 detects that the stage signal R/B changes from the second logical value into the first logical value, the time when the signal standard level changes is the second time. Then, the memory controller 11 calculates the writing time according to the first time and the second time and judges whether the writing time is coincident with a standard value. If not, the memory controller 11 controls the flash memory chip 13 to label the appointed storage paging as a problem storage region or label the region block to which the appointed storage paging belongs as a problem storage region. Then, the memory controller 11 allocates another redundant backup paging, and controls the flash memory chip 13 to copy the written data into the backup paging. Then, the memory controller 11 updates the Mapping Table according to the information of labeling the appointed paging or corresponding region block as problem storage region or the backup information of the written data.

The storage device 10 judges the data storage ability of the paging via data writing period to prevent writing the data to a problem storage region, and ends use of the problem storage region, thus improving the data storage reliability.

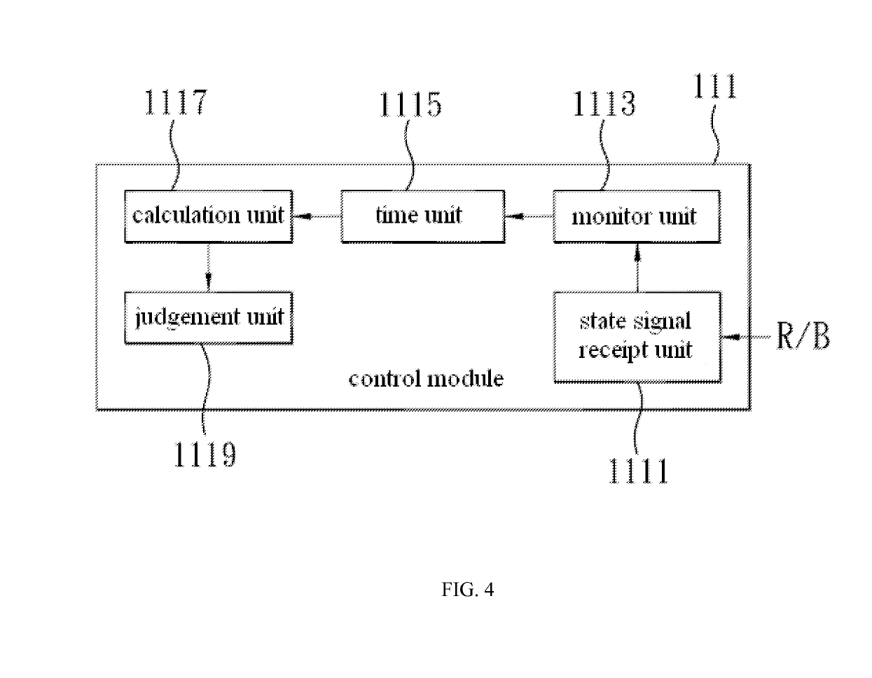

The data writing period monitor mechanism is realized by the control module 111 of the memory controller 11. Please refer to FIG. 4, the control module 111 comprises a state signal receipt unit 1111, a monitor unit 1113, a time unit 1115, a calculation unit 1117 and a judgment unit 1119.

The state signal receipt unit 1111 is coupled to the state output port 1335 of the flash memory chip 13 to receive the state signal R/B. The monitor unit 1113 is coupled to the state signal receipt unit 1111 for monitoring the signal standard level change of the state signal R/B. When the monitor unit 1113 detects that the state signal R/B changes from the first logical value to the second logical value, the time unit 1115 is initiated to get the time when the signal standard level changes as the first time. When the monitor unit 1113 monitors that the state signal R/B changes from the second logical value to the first logical value, the time unit 1115 is initiated again to get the time when the signal standard level changes as the second time. The calculation unit 1117 is coupled to the time unit 1115 to receive the first time and the second time gotten by the time unit 1115, then calculates the difference as the writing time. The judgment unit 1119 is coupled to the calculation unit 1117 to receive the writing time calculated by the calculation unit 1117 and judges whether the writing time is coincident with the standard value. When the judgment unit 1119 judges that the writing time is not coincident with the standard value, then judges the appointed storage paging to which the writing order directs is a problem storage region.

In practice, standard parameters could be set according to above function units and the corresponding operating process and embedded in the memory controller 11 to realize the storage region quality judgment in a writing period. The standard parameters could be set according to the category of the memory. Further, if the flash memory chips have different kinds of memories, then different groups of standard parameters could be set. Then, corresponding standard parameters will be accessed and compared with the writing time according to memory type of the writing paging.

Further explanation to the management of the problem storage regions will be introduced hereinafter. Please refer to FIGS. 2 and 4, the control module 111 controls the flash memory chip 13 further according to the judgment result of the judgment unit 1119. When the judgment unit 1119 judges the appointed storage paging has problem, the control module 111 then sends a control signal to the flash memory chip 13 to control the flash memory chip 13 to label the appointed storage paging or the region block to which the storage paging belongs as a problem storage region. That means, writing indicating codes in particular positions of the problem appointed storage paging or the region block to indicate the destroy of the paging or the region block.

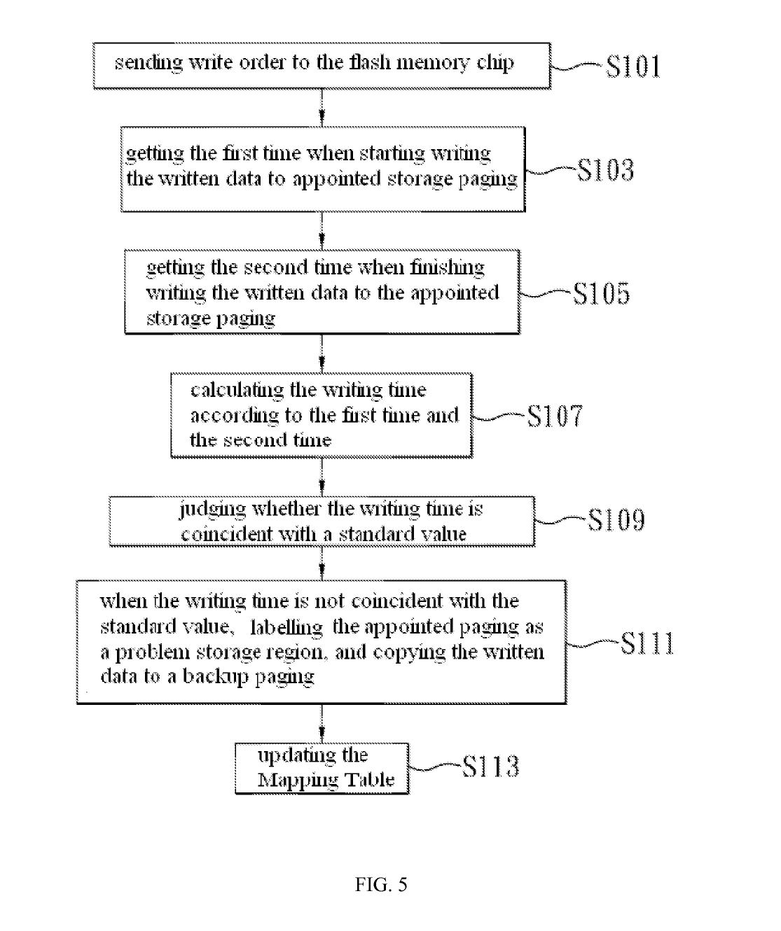

Please refer to FIG. 5 which illustrates the flowchart of the method of judging the problem storage regions in accordance with the first embodiment of the present invention. In FIG. 5, the method of judging the problem storage regions is occurred in a writing period, and FIG. 2 shows the system structure. The method comprises steps of:

S101: the memory controller 11 sends a writing order to the flash memory chip 13 according to a writing command from an outer host for writing the written data to an appointed storage paging. The memory controller 11 sends the written data temporarily stored in the data buffer region 113 to the paging buffer 1311 of the flash memory chip 13 for temporary storage.

S103: when the control module 111 detects the state signal R/B changes from the first logical value to the second logical value, it is judged that the flash memory chip 13 begins writing the written data to the appointed storage paging, that means getting the signal standard level changing time as the first time.

S105: the control module 111 continues monitoring the state signal R/B. When the control module 111 detects the state signal R/B changes from the second logical value to the first logical value, it is judged that the flash memory chip 13 finishes writing the written data to the appointed storage paging, that means getting the signal standard level changing time as the second time.

S107: the control module 111 calculates the writing time according to the first time and the second time, that is the difference between the first time and the second time, and defines the difference as the writing time.

S109: the control module 111 judges whether the writing time is coincident with the standard value. If not, the memory controller 11 controls the flash memory chip 13 to label the appointed storage paging as a problem storage region, and the memory controller 11 allocates another backup paging and controls the flash memory chip 13 to copy the original written data to the backup paging.

S111: the control module 111 updates the Mapping Table according to the information in S109, that is the storage paging is labeled as a problem storage region and the written data is stored in the backup paging.

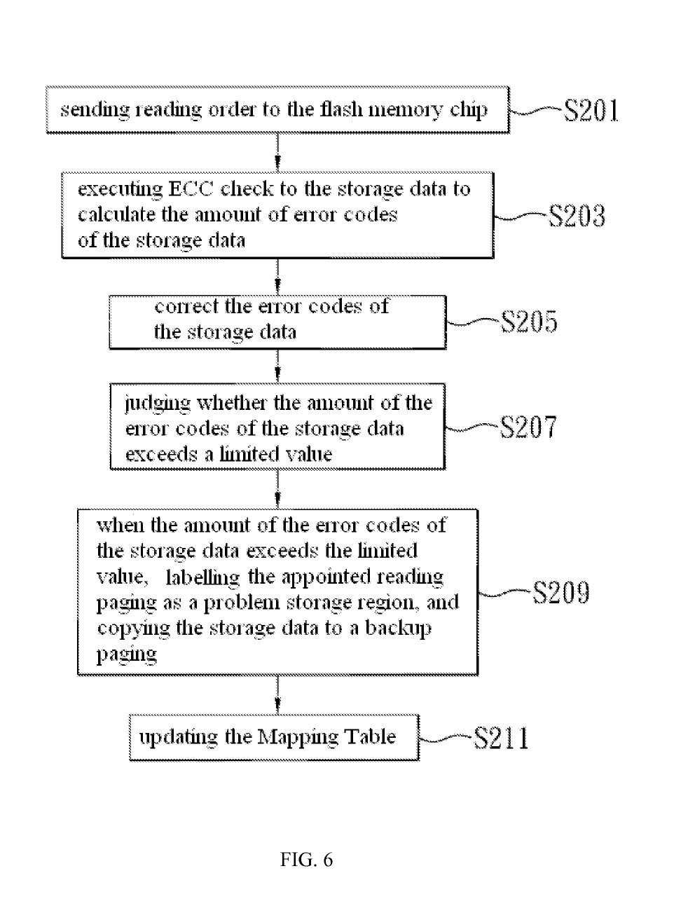

Then, please refer to FIG. 6 which is the flowchart illustrating a method of judging problem storage regions in accordance with the second embodiment of the present invention. In FIG. 6, the method of judging the problem storage regions is occurred in a reading period, and FIG. 2 shows the system structure. The method comprises steps of:

S201: the memory controller 11 sends a reading order to the flash memory chip 13 according to a data reading command from the outer host to read the storage data from the appointed reading paging. The flash memory chip 13 responds to the reading order to send the storage data in the appointed reading paging to the data buffer region 113 for temporary storage.

S203: the memory controller executes error codes detection to the storage data temporarily stored in the data buffer region 113 by the ECC module 115.

S205: the ECC module 115 executes error codes correction to the storage data.

S207: the control module 111 judges whether the amount of the error codes of the storage data exceeds the limited value. If yes, the control module 111 judges that the appointed reading paging has problem, and sends a control signal to the flash memory chip 13 to label the appointed reading paging as a problem storage region.

S209: the control module 111 further allocates a redundant back paging and sends a write data to the flash memory chip 13 to backup the corrected storage data temporarily stored in the data buffer region 113 to the backup paging of the flash memory chip 13.

S211: the control module 111 updates the Mapping Table according to the information of labeling the appointed reading paging as a problem storage region and the backup information of the corrected storage data.

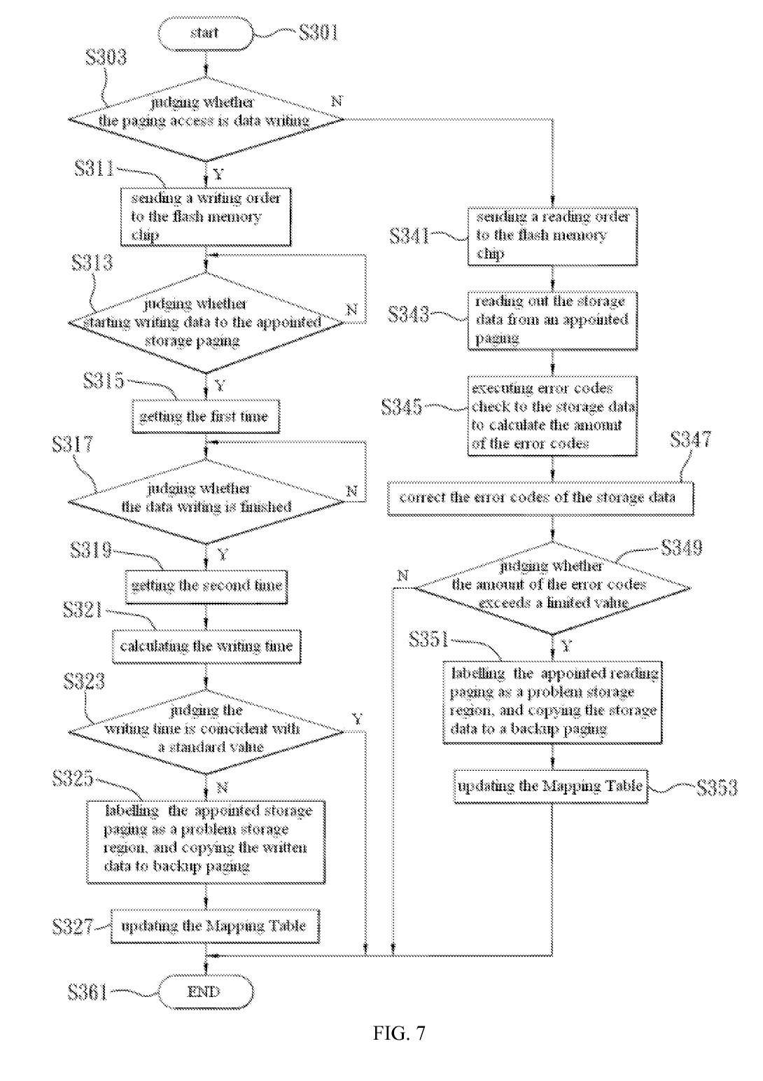

Please refer to FIG. 7, which is a flowchart illustrating a method of judging problem storage region in accordance with the third embodiment of the present invention. In FIG. 7, step details are shown in combination of the writing period and the reading period. As shown in FIG. 7, the method comprises steps of:

S301: the storage device 10 starts the judgment flow of problem storage regions according to the data access command from the outer host.

S303: the memory controller 11 judges whether the paging access to the flash memory chip 13 is data writing.

S311: If yes, the memory controller 11 sends a writing order to the flash memory chip 13.

S313: Then, the memory controller 11 monitors the state signal R/B to judge whether the flash memory chip 13 begins writing the data to the appointed storage paging.

S315: If yes, the control module 111 of the memory controller 11 gets the first time.

S317: then the memory controller 11 continues monitoring the state signal R/B to judge whether the flash memory chip 13 finishes data writing.

S319: If yes, the memory controller 11 gets the second time.

S321: the control module 111 calculates the writing time according to the first time and the second time.

S323: the control module judges whether the writing time is coincident with the standard value.

S361: If the judgment result is yes, the judgment flow of the problem storage regions is ended.

S325: If the judgment result is not, the memory controller 11 controls the flash memory chip 13 to label the appointed writing paging as a problem storage region and backup the original written data to the backup paging.

S327: then the memory controller 11 updates the Mapping Table and turn to S361 to end the judgment flow.

S3431: On the other hand, if the judgment result of step S303 is not, the paging access is data reading, the memory controller 22 sends a reading order to the flash memory chip 13.

S343: then, the flash memory chip 13 reads storage data from the appointed storage paging and sends to the memory controller 11.

S345: the memory controller 11 controls the ECC module 115 to execute error codes detection to the storage data to count the amount of the error codes.

S347: the ECC modules 115 corrects the error codes of the storage data.

S349: then the memory controller 11 judges whether the amount of the error codes of the storage data exceeds the limited value. If no, then turn to step 361 to end the judgment flow.

The method of judging the problem storage region is widely used to all devices, systems and equipments having flash memories to find out and eliminate problem storage regions as early as possible. In actual practice, it is preferred to build the [symbol] of the memory controller according to the method of the present invention, for utilizing the resource of the memory controller to finish the steps. However, it is to be understood, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A method of judging problem storage regions adapted for a flash memory storage device, wherein the flash memory storage device comprises a flash memory chip which comprises a plurality of region blocks, and each region block comprises a plurality of pagings, said method of judging problem storage regions comprising steps of:
sending a writing order to the flash memory chip for writing a written data to an appointed storage paging of said pagings;
getting the first time when said flash memory chip starting writing said written data to the appointed storage paging;
getting the second time when said flash memory chip finishing writing said written data to said appointed storage paging;
calculating a writing time according to the first time and the second time;
judging whether said writing time is coincident with a standard value;
if said writing time is not coincident with the standard value, labeling said appointed storage paging as a problem storage region and copying said written data to a backup paging; and
updating a Mapping Table according to the information of labeling the appointed storage paging as a problem storage region and the backup information of the written data.

2. The method of judging problem storage regions as claimed in claim 1, comprising a step of labeling the region block to which the appointed storage paging belongs as a problem storage region when the writing time is not coincident with the standard value.

3. The method of judging problem storage regions as claimed in claim 1, wherein the flash memory chip comprises a state output port for outputting a state signal, when the flash memory chip is in an armed state, the standard level of the state signal is a first logical value, when the flash memory chip is in a working state, the standard level of the state signal is a second logical value, and the method of judging problem storage regions comprising the step of:
monitoring said state signal; and
when monitoring that the standard level of the state signal changes from the first logical value to the second logical value, judging that the flash memory chip begins writing the written data to the appointed storage paging and getting the changing time of the standard level as the first time.

4. The method of judging problem storage regions as claimed in claim 3, after the step of timing from the first time, comprising a step of:
when monitoring that the standard level of the state signal changes from the second logical value to the first value, judging that the flash memory chip finishes writing the written data to the appointed storage paging and getting the changing time of the standard level as the second time.

5. The method of judging problem storage regions as claimed in claim 3, wherein the flash memory storage device further comprises a memory controller connecting with an outer host and sending a writing/reading order to the flash memory chip.

6. The method of judging problem storage regions as claimed in claim 5, wherein the memory controller comprises a control module coupled to the state output port of the flash memory chip to monitor the state signal and getting the first time and the second time according to the standard level change of the state signal.

7. The method of judging problem storage regions as claimed in claim 6, wherein the control module of the memory controller comprises a calculation unit to calculate the difference between the first time and the second time and get the writing time.

8. The method of judging problem storage regions as claimed in claim 1, further comprising a step of:
sending a reading order to the flash memory chip for reading a storage data from an appointed reading paging from said pagings;
executing error codes detection to the storage data by an ECC module for calculating the amount of the error codes of the storage data;
judging whether the amount of the error codes of the storage data exceeds a limited value;
correcting the error codes of the storage data;
if the amount of the error codes of the storage data exceeds the limited value, labeling the appointed reading paging as a problem storage region and copying the storage data to a backup paging; and
updating said Mapping Table according to the information of labeling the appointed reading paging as the problem storage region and the backup information of the storage data.

9. The method of judging problem storage regions as claimed in claim 8, wherein when the writing time is not coincident with the standard value, labeling the region block to which the appointed reading paging belongs as a problem storage region.

10. The method of judging problem storage regions as claimed in claim 8, wherein the flash memory storage device further comprises a memory controller connecting with an outer host and sending a writing/reading order to the flash memory chip.

11. The method of judging problem storage regions as claimed in claim 10, wherein the memory controller comprises the ECC module to correct error codes of the reading data.

12. A flash memory storage device comprising:
a flash memory chip, comprising a plurality of region blocks each comprising a plurality of pagings, said flash memory chip comprising a state output port for outputting a state signal, wherein when the flash memory chip is in an armed state, the standard level of the state signal is a first logical value, while when the flash memory chip is in a working state, the standard level of the state signal is a second logical value; and
a memory controller for access control to said flash memory chip;
wherein when the memory controller sends a writing order to said flash memory chip for writing a written data to an appointed storage paging of said pagings, the memory controller gets the first time when the state signal changes from the first logical value to the second logical value, and the memory controller gets the second time when the state signal changes from the second logical value to the first logical value;
wherein the memory controller calculates a writing time according to the first time and the second time and judges whether the writing time is coincident with a standard value, if the writing time is not coincident with the standard value, the memory controller controls the flash memory chip to label said appointed storage paging as a problem storage region and copy said written data to a backup paging, and updates a Mapping Table according to the information of labeling the appointed storage paging as the problem storage region and the backup information of said written data.

13. The flash memory storage device as claimed in claim 12, wherein when the memory controller judges that the writing time is not coincident with the standard, then labels the region block to which the appointed storage paging belongs as a problem storage region.

14. The flash memory storage device as claimed in claim 12, wherein the memory controller sends a reading order to the flash memory chip for reading a storage data from an appointed reading paging of said pagings, the memory controller judges whether said appointed reading paging is a problem storage region, said memory controller comprises:
a data buffer region for temporarily storing the storage data;
an ECC module for executing error codes detection to the storage data and calculating the amount of the error codes of the storage data, and correcting the error codes of the storage data; and
a control module for judging whether the amount of the error codes of the storage data exceeds a limited value, when the amount of the error codes of the storage data exceeding the limited value, the control module controlling the flash memory chip to label the appointed storage paging as a problem storage region and controlling the flash memory chip to copy the storage data to a backup paging, and updating the Mapping Table according to the problem storage region information and the backup information of said storage data.

15. The flash memory storage device as claimed in claim 14, wherein the control module comprises
a time unit;
a state signal receipt unit for receiving said state signal;
a monitor unit for monitoring said state signal, wherein when the monitor unit detects the state signal changes from the first logical value to the second logical value, then the time unit is initiated to get the first time, when the monitor unit detects that the state signal changes from the second logical value to the first logical value, then the time unit is initiated to get the second time;
a calculation unit to receive said first time and the second time and calculate said writing time; and
a judgment unit to receive said writing time and judge whether the writing time is coincident with the standard value, if not, the appointed storage paging is labeled as a problem storage region.
